(19) United States
(12) Patent Application Publication
(10) Pub. No.: US 2005/0023433 A1
(43) Pub. Date: Feb. 3, 2005

(54) Resin optical component mold having minute concavo-convex portions and method of manufacturing resin optical component using the same

(75) Inventors: Yoshihiko Ishitaka, Fukushima-ken (JP); Hidenori Chiba, Fukushima-ken (JP); Takayuki Chida, Fukushima-ken (JP); Tetsuya Fukuda, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/900,792

(22) Filed: Jul. 28, 2004

(30) Foreign Application Priority Data
Jul. 31, 2003 (JP) 2003-204597
Jul. 31, 2003 (JP) 2003-204598

(51) Int. Cl. B29D 11/00

(52) U.S. Cl. 249/134; 425/808

(57) ABSTRACT

The resin optical component mold includes a first mold and a second mold for defining a cavity for molding a resin optical component having a minutely concavo-convex shaped surface, on which a plurality of minute concave or convex portions in units of submicrons is formed, by injection molding light transmitting resin. A master mold 36 formed of an inorganic oxide layer having a minutely concavo-convex shaped surface 36a, on which a concavo-convex shape complementary to the concavo-convex shape formed on the minutely concavo-convex shaped surface of the resin optical component is formed, is provided on the internal surface of the first mold.

### BACKGROUND OF THE INVENTION

1. Field of the Invention

The present invention relates to a resin optical component mold having a minutely concavo-convex shaped surface, on which a plurality of minute concave or convex portions in units of submicrons is formed, and a method of forming the resin optical component using the same.

2. Description of the Related Art

Typically, the resin optical component, on which a plurality of minute concave or convex portions in units of submicrons is formed, includes a light guide plate and a reflection preventing layer of an illumination device referred to as a front light provided on the top surface side of a reflective liquid crystal panel.

FIG. 6 is a sectional view of a liquid crystal display device in which a front light including a light guide plate and a reflection preventing layer manufactured by a conventional method is provided. A liquid crystal display device 100 illustrated in FIG. 6 comprises a liquid crystal panel 120 and a front light 110 arranged on the top surface side of the liquid crystal panel 120.

The front light 110 comprises a flat plate-shaped light guide plate 112 and a rod-shaped light source 113 arranged on a side end 112a of the light guide plate 112, introduces the light emitted from the light source 113 from a side end 112a of the light guide plate 112 to the light guide plate 112 and reflects the light by the reflection surface 112c of the light guide plate 112 so that the traveling direction of the light is changed and that the light is radiated from an emission surface 112b of the light guide plate 112 toward the liquid crystal panel 120. A plurality of V-shaped minute concave portions (grooves) 115 is formed in the reflection surface 112c.

In addition, a reflection preventing layer 117 is formed on the emission surface 112b so that it is possible to effectively bleed the light that travels inside the light guide plate 112 to the liquid crystal panel 120 and it possible to prevent the reflected light from the reflective liquid crystal panel 120 from being reflected by the surface of the light guide plate 112 to thus be attenuated. A plurality of minute convex portions (protrusions) referred to as anti-reflective (AR) lattices are formed on the surface of the reflection preventing layer 117.

As a conventional method of manufacturing the resin optical component having a minutely concavo-convex shaped surface, such as the light guide plate 112 and the reflection preventing layer 117, on which a plurality of minute concave or convex portions in units of submicrons is formed, an injection molding method of injecting silicon-based resin that is a material of the optical component into a cavity using a Ni shell in which concavo-convex shape complementary to the minute concavo-convex shape is formed is adopted (refer to Japanese Unexamined Patent Application Publication No. 6-201908, and Japanese Unexamined Patent Application Publication No. 2002-372603). In order to manufacture the Ni shell, a master mold having the same concavo-convex shape as the outward shape of the resin optical component is used. After attaching Ni having a required thickness on the surface of the master mold by electrolysis, the Ni shell is released from the master mold to thus obtain the shell having the surface with the concavo-convex shape complementary to the concavo-convex shape on the surface of the master mold.

However, according to the conventional method of manufacturing the resin optical component using the Ni shell, when the resin optical component, having the minutely concavo-convex shaped surface, on which the minute convex or concave portions in units of submicrons are formed, is manufactured, since the degree of precision at which the concavo-convex shape of the master mold is transcribed to the Ni shell is typically low, the degree of precision of the size of the finally obtained resin optical component deteriorates. Also, since the release property of the resin injected mold (the resin optical component) released from the Ni shell is poor, it becomes difficult to improve the manufacturing efficiency. Such a problem is more noticeable when the resin optical component, in which the aspect ratio of the minute convex or concave portions of the minute concavo-convex surface is no less than 1, is manufactured, and more specifically, the height of the convex portions or the depth of the concave portions of the resin optical component may be smaller than a target size by 10% or more.

In addition, in order to facilitate the mold release operation, the surface of the Ni shell may be coated with a release agent such as wax or silicon oil having a high melting point. However, it is troublesome to coat the surface of the Ni shell with the release agent. In addition, since it is necessary to coat the surface of the Ni shell with the release agent whenever shot several times, the manufacturing efficiency deteriorates.

### SUMMARY OF THE INVENTION

To solve the above problems, it is an object of the present invention to provide a resin optical component mold capable of manufacturing a resin optical component having a minutely concavo-convex shaped surface, on which a plurality of minute concave or convex portions in units of submicrons is formed, at a high degree of precision of size and of improving release property when a resin injected mold is released from the mold.

It is another object of the present invention to provide a method of manufacturing a resin optical component capable of manufacturing a resin optical component having a minutely concavo-convex shaped surface, on which a plurality of minute concave or convex portions in units of submicrons is formed, at a good degree of precision of size and of improving release property of a resin injected mold to thus improve the manufacturing efficiency.

In order to solve the above problems, there is provided a resin optical component mold having a minutely concavo-convex shaped surface, on which a plurality of minute concave or convex portions in units of submicrons is formed, by injection molding light transmitting resin. The resin optical component mold comprises a first mold and a second mold for defining a cavity for molding a resin optical component having the minutely concavo-convex shaped surface, on which a plurality of minute concave or convex portions in units of submicrons is formed. A master mold formed of an inorganic oxide layer having a minutely concavo-convex shaped surface, on which a concavo-convex shape complementary to the concavo-convex shape of the minutely concavo-convex shaped surface of the resin optical component is formed, is provided on at lease one internal surface of the first mold and the second mold.

According to the resin optical component mold of the present invention, the master mold formed of the inorganic oxide layer having a minutely concavo-convex shaped surface, on which the concavo-convex shape complementary to the concavo-convex shape formed on the minutely concavo-convex shaped surface of the resin optical component is formed, is provided on the internal surface of at least one of the first mold and the second mold. Thus, when the light transmitting resin is injected into the cavity during the manufacturing of the resin optical component, it is possible to directly transcribe the minute concavo-convex shape on the surface of the master mold to the resin injected mold (the resin optical component) and to prevent the mold from being damaged during the molding process. As a result, it is possible to manufacture a resin optical component having a minutely concavo-convex shaped surface, on which a plurality of minute concave or convex portions in units of submicrons is formed, at a higher degree of precision of size than in the Ni shell to which the concavo-convex shape of the master mold is transcribed by a conventional art. In addition, since the master mold is formed of an inorganic oxide layer, it is possible to improve the release property when the resin injected mold is released from the master mold.

According to the resin optical component mold of the present invention, a coating layer, whose surface free energy is no more than 4 μJ/cm², is formed on the surface of the master mold, where the minute concavo-convex portions are formed. Thus, a physical bond with a molded substance (the resin injected mold) becomes low to improve the release property when the resin injected mold is released from the mold. In addition, since the coating layer is formed to prevent the surface of the master mold, on which the minute concavo-convex portions are formed, from being exposed to be protected, it is possible to improve the chemical resistance property and the rub resistance property of the master mold. When injection molding is performed using the resin optical component mold according to the present invention, since the gas generated by pyrolyzing a molding material such as light transmitting resin is attached to the internal surface of the mold, it is necessary to perform maintenances such as clearing agents whenever shot tens of thousands times. Since the master mold may be damaged by some clearing agents used for the clearing process, it is necessary to coat the surface of the master mold, on which the minute concavo-convex portions are formed, with the coating layer so that it is possible to maintain the shape of the master mold although the master mold is exposed to liquid chemical such as the cleaning agents and to prolong the life of the master mold. In particular, when the master mold is formed of a SiO₂ layer as mentioned later, since SiO₂ is not resistant to (has weak alkali resistance) strongly alkaline cleaning agents, the master mold may be easily damaged. Thus, when the coating layer is formed, it is possible to prevent the master mold from being damaged and to maintain the shape of the master mold.

According to the resin optical component mold of the present invention, the coating layer formed on the surface of the master mold, on which the minute concavo-convex portions are formed, may be formed of a diamond-like carbon (DLC) layer containing fluorine or a silane compound layer having a fluorine structure. When the coating layer is formed of the diamond-like carbon layer containing fluorine, since the coating layer contains fluorine, the surface free energy of the coating layer is reduced and the physical bond with the resin injected mold (the molded substance) becomes low. Thus, it is possible to improve the release property when the resin injected mold is released from the mold. In addition, when the diamond-like carbon (DLC) layer is used, since it is possible to reduce the surface roughness of the coating layer, it is possible to reduce friction coefficient between the master mold and the molded substance (to be specific, between the coating layer and the molded substance) when the molded substance is released from the mold and to thus improve the release property.

In addition, since the DLC layer may be formed by a sputtering method to be dense, it is possible to protect the master mold and to improve the chemical resistance property and the friction resistance property of the master mold by coating the surface of the master mold, on which the minute concavo-convex portions are formed, with the coating layer formed of the DLC layer.

When the coating layer is formed of the silane compound layer having the fluorine structure, since the coating layer has the fluorine structure, it is possible to reduce the surface free energy of the coating layer and to weaken the physical bond with the resin injected mold (the molded substance). Thus, it is possible to improve the release property when the resin injected mold is released from the mold.

In addition, that the coating layer has the fluorine structure means that the coating layer has fluorine atoms in molecules by chemical bond.

When the coating layer is formed of the DLC layer containing fluorine, the coating layer may have gradient in the concentration of fluorine in the direction of the thickness of the coating layer.

The surface of the coating layer formed on the surface of the master mold, on which the minute concavo-convex portions are formed, according to the present invention may have the surface free energy of no more than 4 μJ/cm² (no more than 40 erg/cm²). Since the surface of the master mold, on which the minute concavo-convex portions are formed, preferably adheres closely to the inorganic oxide layer that constitutes the master mold, gradient is given to the concentration of fluorine by making the concentration of fluorine in the surface of the master mold, on which the minute concavo-convex portions are formed, less than the concentration of fluorine in the surface of the coating layer.

In addition, according to the resin optical component mold of the present invention, the thickness of the coating layer is preferably no more than 50 nm. When the thickness of the coating layer is no more than 50 nm, since the same concavo-convex portions as the minute concavo-convex portions on the surface of the master mold are formed on the coating layer, it is possible to manufacture a resin optical component having a high degree of size precision without affecting the shape of the resin injected mold.

In addition, according to the resin optical component mold of the present invention, the surface of the master mold, on which the minute concavo-convex portions are formed, is preferably coated with a protective film made of a liquid resistant material because of the following reasons. When injection molding is performed using the resin optical component mold according to the present invention, since the gas generated by pyrolyzing a molding material such as light transmitting resin is attached to the internal surface of the mold, it is necessary to perform maintenances such as clearing agents whenever shot tens of thousands times. Since the master mold may be damaged by some clearing agents used for the clearing process, it is necessary to form a protective film made of a liquid resistant material on the surface of the master mold, on which the minute concavo-convex portions are formed, so that it is possible to maintain the shape of the master mold and to prolong the life of the master mold. In particular, when the master mold is formed of the SiO₂ layer, since SiO₂ is not resistant to (has weak alkali resistance) strong alkaline clearing agents, the master mold may be easily damaged. Thus, when the protective film having good alkali resistance is formed as mentioned above, it is possible to prevent the master mold from being damaged and to maintain the shape of the master mold. Oxide such as the diamond-like carbon (DLC) and TiO₂ is used as the liquid resistant material that constitutes the protective film. A metal film such as a Ni film may be used as the protective film. In such a case, it is possible to reform the surface of the master mold and to thus improve the release property when the resin injected mold is released from the master mold.

In addition, according to the resin optical component mold of the present invention, the thickness of the protective film is preferably no more than 50 nm.

When the thickness of the coating layer is no more than 50 nm, since the same concavo-convex portions as the minute concavo-convex portions on the surface of the master mold are formed on the coating layer, it is possible to manufacture the resin optical component having a high degree of size precision without affecting the shape of the resin injected mold.

According to the resin optical component mold of the present invention, the aspect ratio of the minute concave or convex portions formed on the surface of the master mold (the ratio of depth to width or the ratio of depth to pitch of the concave portions in the case of the concave portions and the ratio of height to width or the ratio of height to pitch of the convex portions in the case of the convex portions) may be no less than 1.

According to the resin optical component mold having the above-mentioned structure, even when the aspect ratio of the minute concave or convex portions formed on the surfaces of the resin optical component is no less than 1, it is possible to manufacture the resin optical component with a high degree of size precision.

In addition, according to the resin optical component mold of the present invention, the master mold is preferably formed of the SiO₂ layer.

There is provided a method of manufacturing a resin optical component having a minutely concavo-convex shaped surface, on which a plurality of minute concave or convex portions in units of submicrons is formed by an injection molding method using a mold. Light transmitting resin is injection molded in the cavity of the mold using the resin optical component mold according to claim 1 or 2 as the mold and the minute concavo-convex shape of the minutely concavo-convex shaped surface of the master mold is transcribed to the resin optical component.

According to the method of manufacturing the resin optical component having the minutely concavo-convex shaped surface, on which the minute concavo-convex portions having the above structure are formed, it is possible to manufacture the resin optical component having a minutely concavo-convex shaped surface, on which a plurality of minute concave or convex portions in units of submicrons is formed, with a high degree of size precision. Furthermore, when the resin injected mold is released from the master mold, the release property is excellent. As a result, it is possible to effectively manufacture the above-mentioned resin optical component:

### BRIEF DESCRIPTION OF THE DRAWINGS

FIG. 1 is a sectional view illustrating an embodiment of a liquid crystal display device comprising a reflection preventing layer manufactured by a method of manufacturing resin optical component having a minutely concavo-convex shaped surface, on which minute concavo-convex portions are formed, according to the present invention;

FIG. 2 is a partial perspective view schematically illustrating the shape of the surface of the reflection preventing layer illustrated in FIG. 1;

FIG. 3 is a partial sectional view of the reflection preventing layer of FIG. 2;

FIG. 4 is a sectional view illustrating a schematic structure of a reflection preventing layer mold used for manufacturing the reflection preventing layer of FIG. 2;

FIG. 5 is a view illustrating a partial enlargement of a master mold included in the reflection preventing layer mold of FIG. 4; and

FIG. 6 is a sectional view schematically illustrating a structure of a section of the liquid crystal display device having a light guide plate and a reflection preventing layer manufactured by a conventional manufacturing method.

### DESCRIPTION OF THE PREFERRED EMBODIMENTS

Hereinafter, embodiments of the present invention will be described with reference to the accompanying drawings.

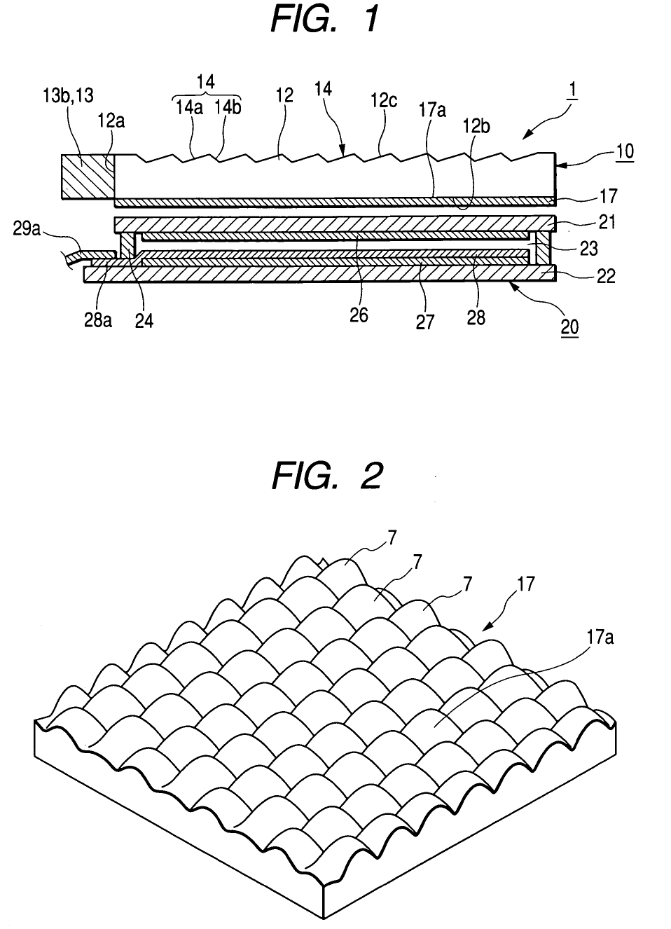

FIG. 1 is a sectional view illustrating an embodiment of a liquid crystal display device comprising a reflection preventing layer manufactured by a method of manufacturing a resin optical component having a minutely concavo-convex shaped surface, on which minute concavo-convex portions are formed, according to the present invention. The liquid crystal display device 1 includes a reflective type liquid crystal panel 20 and a front light (an illumination device) 10 arranged on the top surface side of the liquid crystal panel 20.

A front light 10 comprises a substantially flat plate-shaped transparent light guide plate 12 and a light source 13 arranged on the side end (the light incidence surface) 12a of the light guide plate 12. The light guide plate 12 is made of light transmitting resin such as acryl-based resin and polycarbonate based resin. An emission surface 12b to which the illumination light of the front light 10 is emitted is provided on the lower end side (on the liquid crystal display unit 20 side) of the light guide plate 12. A prism triangular in plan view is formed on the top surface side (on the side opposite to the liquid crystal display unit 20) of the light guide plate 12. In further detail, a plurality of convex portions 14 triangular in plan view and composed of slightly inclined portions 14a inclined with respect to the emission surface 12b and steeply inclined portions 14b inclined at a larger inclination angle than the inclination angle at which the slightly inclined portions 14a are inclined are formed parallel to each other. In addition, a reflection preventing layer (resin optical component) 17 is formed on the emission surface 12b of the light guide plate 12.

The light source 13 arranged on the side end 12a of the light guide plate 12 is a rod-shaped light source provided along the side end 12a of the light guide plate 12. To be specific, light emitting elements 13a composed of white light emitting diodes (LED) are arranged on both ends of a rod-shaped light guide body 13b. In addition, the light emitted from the light emitting elements 13a is introduced to the light guide plate 12 through the light guide body 13b. It is possible to uniformly radiate the light of the light emitting elements 13a that are a point light source onto the side end 12a of the light guide plate 12 by providing the rod-shaped light guide body 13b between the light emitting elements 13a and the light guide plate 12 as mentioned above. Any light source whose light can be introduced to the side end 12a of the light guide plate 12 can be used as the light source 13. For example, the light emitting elements can be arranged in parallel along the side end 12a of the light guide plate 12. In addition, one light emitting element 13a may be included.

According to the front light 10 having the above-mentioned structure, the light emitted from the light source 13 is introduced from the side end 12a of the light guide plate 12 to the inside of the light guide plate 12 so that the light that travels inside the light guide plate 12 is reflected by the steeply inclined portions 14b of the convex portions 14 provided on the reflection surface 12c to change its traveling direction. As a result, the light is emitted from the emission surface 12b as illumination light.

The reflection preventing layer 17 manufactured by a manufacturing method according to the present invention is provided on the emission surface 12b of the light guide plate 12 of the front light 10 according to the present embodiment. Minute concave or convex portions in units of submicrons are arranged on the surface of the reflection preventing layer 17 in a matrix.

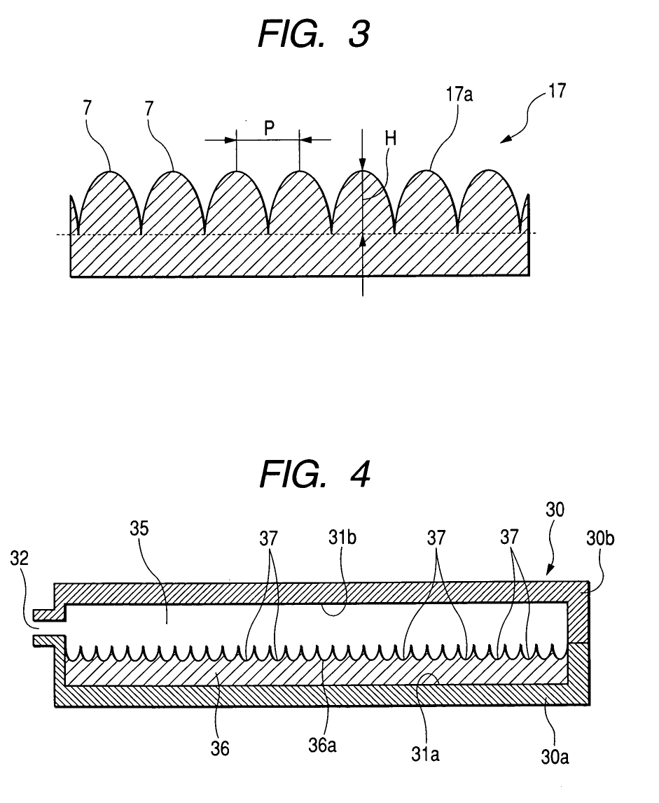

The reflection preventing layer 17 will now be described with reference to FIGS. 2 and 3. FIG. 2 is a partial perspective view schematically illustrating the shape of the surface of the reflection preventing layer 17. FIG. 3 is a partial sectional view of the reflection preventing layer 17 of FIG. 2.

A plurality of minute convex portions 7 having a diameter of about 0.15 to 0.4 μm (or the pitch of the convex portions 7 is about 0.15 to 0.4 μm) is arranged on one surface (a light guide plate side surface) of the reflection preventing layer 17 in a matrix so that it is possible to transmit light having a wide wavelength band at high transmittance. It is possible to prevent light from being reflected by providing the minute concavo-convex portions as mentioned above because the convex portions are arranged to a height no more than the wavelength in a visible region and with a repeated pitch such that the incident light is not reflected. The surface of the reflection preventing layer 17, on which the plurality of above-mentioned minute convex portions 7 is provided, is referred to as a minutely concavo-convex shaped surface 17a. The reflection preventing layer 17 is arranged such that the minutely concavo-convex shaped surface 17a is on the side of the emission surface 12b of the light guide plate 12.

Since the above-mentioned reflection preventing layer 17 is provided, when the light that travels inside the light guide plate 12 is incident on the emission surface 12b, almost no light is reflected such that it is possible to effectively illuminate the liquid crystal panel 20. In addition, since almost no light is reflected from the internal surface of the emission surface 12b, it is possible to prevent a whitening phenomenon caused by the light reflected by the emission surface 12b reaching a user from occurring. As a result, contrast can be improved and high quality images can be displayed.

In addition, when the light reflected by the reflective type liquid crystal panel 20 is incident on the emission surface 12b of the light guide plate 12, the reflection preventing layer 17 transmits the reflected light of the liquid crystal panel 20 at high transmittance to thus display images having high brightness. This is because, when the reflected light of the liquid crystal panel 20 is reflected by the emission surface 12b of the light guide plate 12, a part of the light to be displayed is lost to deteriorate the brightness and the whitening phenomenon of the light guide plate 12 is caused by the light reflected by the emission surface 12b to deteriorate display contrast. However, it is possible to prevent the whitening phenomenon from occurring by the structure in which the reflection preventing layer 17 is provided in the light guide plate 12.

In addition, the diameter or the pitch of the convex portions 7 is preferably no more than 0.3 μm. The height H of the convex portions 7 is preferably no less than 0.13 μm. This is because, when the pitch P is larger than 0.3 μm, colors are generated in the case of being incident on the light guide plate. When the height H of the convex portions 7 is less than 0.13 μm, the reflection preventing effect is insufficient to thus increase reflectance.

The smaller the pitch of the convex portions 7 is, the larger the transmittance of the reflection preventing layer 17 is. However, since it is difficult to uniformly arrange the extremely minute convex portions 7 having the pitch no more than 0.13 μm, which causes increases in manufacturing costs, the lowest limit of the pitch of the convex portions 7 is about 0.20 μm. The aspect ratio (the ratio of the pitch P of the convex portions 7 to the height H) of the convex portions 7 is no less than 1 and is preferably in the range of no less than 1 and no more than 2. This is because, when the aspect ratio of the convex portions 7 is less than 1, it is not possible to obtain a sufficient reflection preventing effect. The reflection preventing layer 17 is made of light transmitting resin such as silicon-based resin, acryl resin, and norbornene resin.

In the light guide plate 12 according to the present invention, the reflection preventing layer 17 is not provided only on the emission surface 12b but may be also provided on the side end 12a on which the light source 13 is arranged. By the above-mentioned configuration, it is also possible to prevent light from being reflected by the side end 12a of the light guide plate 12 when the light is introduced from the light source 13 (the light guide body 13b) to the light guide plate 12 so that it is possible to improve the efficiency of the light source and to thus improve the brightness of the front light 10. The case in which the plurality of minute convex portions 7 is provided on the light guide plate side surface as the reflection preventing layer 17 was described. However, a plurality of minute concave portions in units of submicrons may be provided on the light guide plate side surface. In addition, the case in which the minutely concavo-convex shaped surface is provided on the light guide plate side surface as the reflection preventing layer 17 was described. However, the minutely concavo-convex shaped surface may be provided on both surfaces (the light guide plate side surface and the liquid crystal panel side surface) of the reflection preventing layer 17.

In the liquid crystal panel 20, a liquid crystal layer 23 is interposed between an upper substrate 21 and a lower substrate 22 arranged to face each other and the liquid crystal layer 23 is sealed by a sealing material 24 provided along the circumferences on the internal surface side of the substrates 21 and 22 in a frame shape.

A liquid crystal control layer 26 is formed on the internal surface (on the lower substrate 22 side) of the upper substrate 21. A reflection layer 27 having a metal thin film for reflecting the illumination light of the front light 10 or external light is formed on the internal surface (on the upper substrate 21 side) of the lower substrate 22. A liquid crystal control layer 28 is formed on the reflection layer 27.

The liquid crystal control layers 26 and 28 include electrodes for driving and controlling the liquid crystal layer 23, alignment films, and semiconductor elements for switching the electrodes. If necessary, the liquid crystal control layers 26 and 28 may include color filters for displaying colors. As illustrated in FIG. 1, the liquid crystal control layer 28 on the lower substrate 22 side extends to the outside over the sealing material 24. The tip 28a of the liquid crystal control layer 28 is connected to a flexible substrate 29a. The liquid crystal control layer 26 on the upper substrate 21 side is connected to a flexible substrate (not shown).

The reflecting layer 27 includes a reflecting film composed of a high reflectance metal thin film such as aluminum and silver for reflecting the external light incident on the liquid crystal display panel 20 and the illumination light of the front light 10, and preferably includes light scattering means for preventing the visibility of the liquid crystal display device from deteriorating because reflected light is intensive in a specific direction. The metal reflecting film on whose surface a minute concavo-convex shape is formed, or a scattering film obtained by scattering resin beads having refractive index different from the refractive index of the material that constitutes a resin film in the resin film may be used as the light scattering means.

The liquid crystal display device 1 according to the present embodiment having the above-mentioned structure can perform reflective display using external light in an environment where it is possible to obtain sufficient external light and can display images using the light emitted from the emission surface 12b of the light guide plate 12 as illumination light by turning the front light 10 on in an environment where it is not possible to obtain the external light. Since it is possible to effectively extract the light introduced from the light source 13 to the inside of the light guide plate 12 from the emission surface 12b by providing the reflection preventing layer 17 on the light guide plate 12 of the front light 10, it is possible to improve the amount of the illumination light incident on the liquid crystal panel 20 and to thus display high brightness images.

In addition, the light incident on the liquid crystal panel 20 is reflected by the reflecting layer 27 of the lower substrate 22, is incident on the light guide plate 12, passes through the light guide plate 12, and reaches a user. However, according to the liquid crystal display device 1 of the present embodiment, since the reflection preventing layer 17 is provided on the light guide plate 12, almost no reflected light from the liquid crystal panel 20 is reflected by the emission surface 12b of the light guide plate and reaches the user. Thus, it is possible to prevent the light from being reflected by the emission surface 12b of the light guide plate 12 and to thus prevent the brightness of display light from deteriorating. In addition, since it is possible to prevent the light from being reflected by the emission surface 12b and to thus prevent the whitening phenomenon of the light guide plate 12 from occurring, images having a high contrast and brightness can be displayed.

(Method of Manufacturing Reflection Preventing Layer)

Next, a method of manufacturing a reflection preventing layer according to the present embodiment will now be described.

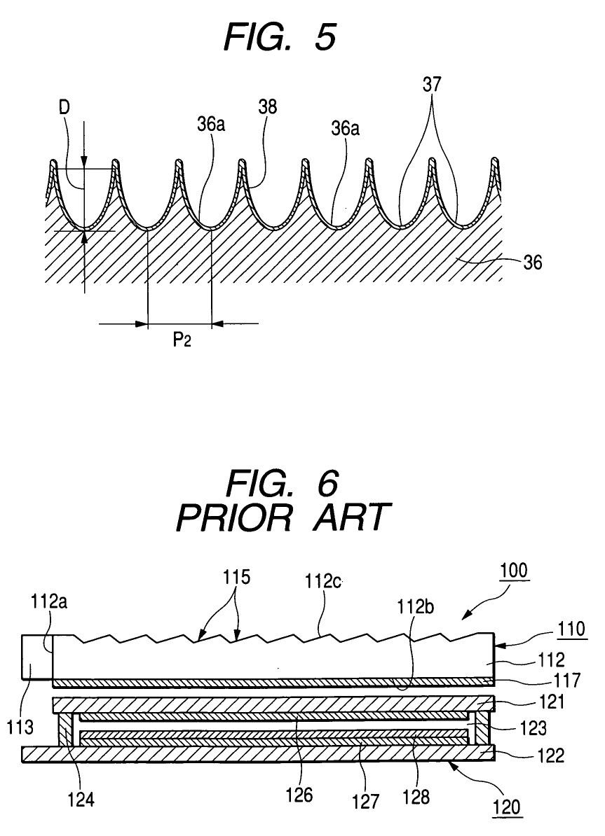

The reflection preventing layer 17 illustrated in FIG. 1 can be manufactured by injection molding using a reflection preventing layer mold (resin optical component mold) illustrated in FIGS. 4 and 5. FIG. 4 is a sectional view illustrating a schematic structure of a reflection preventing layer mold 30. FIG. 5 is a view illustrating a partial enlargement of a master mold included in the reflection preventing layer mold 30 of the FIG. 4.

The reflection preventing layer mold 30 comprises a first mold 30a and a second mold 30b that define a cavity 35 for molding the reflection preventing layer 17. A master mold 36 formed of an inorganic oxide layer having a minutely concavo-convex shaped surface 36a having concavo-convex shape complementary to the concavo-convex shape on the minutely concavo-convex shaped surface 17a of the reflection preventing layer 17 is arranged on the internal surface 31a of the first mold 30a. An internal surface 31b of the second mold 30b is used for molding the surface opposite to the minutely concavo-convex shaped surface 17a of the reflection preventing layer 17. In addition, an injection opening 32 through which silicon-based resin that constitutes the reflection preventing layer 17 is injected is formed on the side ends of the first mold 30a and the second mold 30b.

The first mold 30a and the second mold 30b may be made of ceramic such as silicon wafer.

The minutely concavo-convex shaped surface 36a of the master mold 36 has a plurality of minute concave portions 37 in units of submicrons and the concave portions 37 are arranged in a matrix. The diameter or the pitch P2 of the concave portions 37 is 0.15 to 0.4 μm, which is almost equal to the diameter or the pitch P of the convex portions 7 of the reflection preventing layer 17, and is preferably no more than 0.3 μm.

The height H₂ of the concave portions 37 is no less than 0.2 μm, which is almost equal to the height H of the convex portions 7. In addition, the aspect ratio (the ratio of the depth D to the pitch P₂ of the concave portions 37) of the concave portions 37 is no less than 1, which is almost equal to the aspect ratio of the convex portions 7, and is preferably in the range of no less than 1 and no more than 2.

The minutely concavo-convex shaped surface 36a of the master mold 36 is coated with a coating layer 38 whose surface free energy is no more than 4 μJ/cm² (no more than 40 erg/cm²) and is preferably no more than 3.5 μJ/cm² (no more than 35 erg/cm²). When the surface free energy of the coating layer 38 is larger than 4 μJ/cm², since physical bond with the molded substance (the resin injected mold) increases, the release property deteriorates when the resin injected mold is released from the mold.

The same concavo-convex shape as the concavo-convex shape of the minutely concavo-convex shaped surface 36a of the master mold 36 is formed on the surface of the coating layer 38.

The coating layer 38 is composed of the DLC layer containing fluorine or a silane compound having a fluorine structure.

When the coating layer 38 is formed of the DLC layer containing fluorine, the amount of fluorine in the coating layer 38 is controlled such that the surface free energy is no more than 4 μJ/cm². The amount of fluorine in the coating layer 38 is preferably in the range of 10 wt % to 30 wt % (or 10 mass % to 30 mass %) such that it is possible to improve the release property and the adhesion to the mold. As the amount of fluorine in the coating layer 38 increases, the release property improves. As the amount of fluorine is reduced, the adhesion to the mold 30a deteriorates. Thus, the concentration of fluorine on the minutely concavo-convex shaped surface 36a side may be lesser than the concentration of fluorine in the surface of the coating layer 38 (on the cavity 35 side) to give gradient to the concentration in fluorine in the direction of the thickness of the coating layer 38. The DLC layer in which gradient is given to the concentration of fluorine in the direction of the thickness of the coating layer 38 is referred to as an inclined FDLC layer.

The surface free energy of the coating layer 38 formed of the inclined FDLC layer is no more than 40 erg/cm². Thus, the surface of the coating layer 38 can have good release property and the minutely concavo-convex shaped surface 36a closely adheres to the inorganic oxide layer that constitutes the master mold.

The thickness of the coating layer 38 is preferably no more than 50 nm because of the above-mentioned reason and more preferably, is no more than 30 μm.

According to the manufacturing method of the coating layer 38, in the case of the DLC layer containing fluorine, the coating layer 38 can be formed by performing sputtering in an atmosphere containing fluorine. In the case of the inclined FDLC layer, the coating layer 38 can be formed by performing sputtering while changing the concentration of fluorine in the atmosphere. In the case of the silane compound layer having the fluorine structure, the coating layer 38 can be formed by performing deep coating.

In addition, the minutely concavo-convex shaped surface 36a of the master mold 36 may be coated with the protective film 38 made of a liquid resistant material instead of the coating layer. The same concavo-convex shape as the concavo-convex shape on the minutely concavo-convex shaped surface 36a of the master mold 36 is formed on the surface of the protective film 38.

Oxide such as diamond-like carbon (DLC) and TiO₂ is used as the liquid resistant material that constitutes the protective film 38.

In addition, the protective film 38 may be formed of a metal film such as a nickel film. In such a case, it is possible to reform the surface of the master mold 36 and to thus improve the release property.

The thickness of the protective film 38 is preferably no more than 50 nm because of the above-mentioned reason and is more preferably no more than 30 nm.

According to the method of manufacturing the protective film 38, in the case of the oxide film such as DLC, the protective film 38 may be formed by the sputtering method.

In order to manufacture the reflection preventing layer 17 using the above-mentioned reflection preventing layer mold 30, the reflection preventing layer mold 30 is set in an injection mold and light transmitting resin such as silicon-based resin of the material of the reflection preventing layer 17, which is melt, is injected into the injection opening 32 to thus mold the resin injected mold. As a result, it is possible to mold the resin injected mold to which the minute concavo-convex shape of the minutely concavo-convex shaped surface 36a of the master mold 36 is transcribed. Then, the resin injected mold is released from the master mold to thus obtain a desired reflection preventing layer 17.

According to the method of manufacturing the reflection preventing layer of the present embodiment, since injection molding is performed using the reflection preventing layer mold 30 having the above structure, it is possible to transcribe the concavo-convex shape of the minutely concavo-convex shape surface 36a of the master mold 36 to the resin injected mold. Furthermore, since it is possible to prevent the resin injected mold from being damaged during the molding process, it is possible to manufacture the reflection preventing layer 17 having the minutely concavo-convex shaped surface 17a, on which the plurality of minute convex portions 7 in units of submicrons is formed, with a high degree of size precision compared to the Ni shell to which the concavo-convex shape of the master mold is transcribed according to a conventional art. Since the master mold 36 is made of an inorganic oxide, it is possible to improve the release property when the resin injected mold is released from the mold and to thus effectively manufacture the reflection preventing layer 17.

Since the coating layer 38 whose surface free energy is no more than 4 μJ/cm² is formed on the minutely concavo-convex shaped surface 36a of the master mold 36, the physical bond with the resin injected mold is low. Thus, it is possible to improve the release property when the resin injected mold is released from the mold and to effectively manufacture the reflection preventing layer 17. Since the coating layer 38 or the protecting layer 38 is formed on the minutely concavo-convex shaped surface 36a of the master mold 36, the minutely concavo-convex shaped surface 36a of the master mold 36 is not exposed to clearing agents. Thus, it is possible to prevent the shape of the minutely concavo-convex shaped surface 36a of the master mold 36 from being damaged by the clearing agents used during the maintenance of the reflection preventing layer mold 30 and thus the life of the mold can be prolonged.

In the reflection preventing layer mold 30, when the same master mold as the master mold 36 as mentioned above is arranged on the internal surface 31b of the second mold 30b to perform injection molding using the above-mentioned reflection preventing layer mold, it is possible to manufacture a reflection preventing layer on whose both surfaces (the light guide plate side surface and the liquid crystal panel side surface) the minutely concavo-convex shaped surface is formed.

According to the above-mentioned embodiment, the reflection preventing layer is manufactured using the resin optical component mold. However, the method of manufacturing the resin optical component according to the present invention can be used for manufacturing the light guide plate 12. When a mold in which a master mold having the minutely concavo-convex shape surface having the concavo-convex shape complementary to the minutely concavo-convex shaped surface (the surface on which the plurality of convex portions 14 are formed, in FIG. 1, the reflection surface 12c) of the light guide plate 12 is provided on the internal surface of either the first mold or the second mold, and the surface for molding the emission surface 12b of the light guide plate 12 is formed on the internal surface of the other mold is used as a light guide plate mold to thus perform injection molding, it is possible to manufacture the light guide plate 12.

### First Embodiment

The same reflection preventing layer mold as that illustrated in FIGS. 4 and 5 was manufactured. The pitch of the concave portions of the minutely concavo-convex shaped surface of the master mold included in the manufactured reflection preventing layer mold was 0.22 μm, and the aspect ratio of the concave portions was 1.2. In addition, the coating layer with which the minutely concavo-convex shaped surface of the master mold was coated was formed of the inclined FDLC layer. The thickness of the inclined FDLC layer was 30 nm. In addition, the surface free energy of the inclined FDLC layer was 3.12 μJ/cm² (31.2 erg/cm²). Next, the manufactured reflection preventing layer mold was set in the injection mold, ARTON (product name), manufactured by JSR Corporation, that was a material of the reflection preventing layer in its melt state, was injected into the injection opening to thus mold the resin injected mold, and the resin injected mold was released from the master mold to thus obtain the reflection preventing layer. The minute concavo-convex shape of the minutely concavo-convex shaped surface of the master mold was transcribed to the obtained reflection preventing layer, which has a minutely concavo-convex shaped surface with a high degree of size precision. The contact work amount (Wbs) of the coating layer when the resin injected mold was released from the master mold was 7.42 μJ/cm² (74.2 erg/cm²). The release property was excellent. The material of the reflection preventing layer was not attached to the coating layer formed on the minutely concavo-convex shaped surface of the master mold.

### Second Embodiment

The same reflection preventing layer mold as that illustrated in FIGS. 4 and 5 was manufactured. The pitch of the concave portions of the minutely concavo-convex shaped surface of the master mold included in the manufactured reflection preventing layer mold was 0.25 μm and the aspect ratio of the concave portions was 1.3. The coating layer with which the minutely concavo-convex shaped surface of the master mold was coated was made of AY43-158 (silane compound having a fluorine structure) manufactured by Toray Industries, Inc. The thickness of the coating layer was 10 nm. The surface free energy of the coating layer was 1.6 μJ/cm² (16.0 erg/cm²).

Next, the manufactured reflection preventing layer mold was set in the injection mold, ARTON (product name), manufactured by JSR Corporation, that was a material of the reflection preventing layer in its melt state, was injected into the injection opening to thus mold the resin injected mold, and the resin injected mold was released from the master mold to thus obtain the reflection preventing layer. The minute concavo-convex shape of the minutely concavo-convex shaped surface of the master mold was transcribed to the obtained reflection preventing layer, which had a minutely concavo-convex shaped surface with a high degree of size precision. The contact work amount (Wbs) of the coating layer when the resin injected mold was released from the master mold is 4.55 μJ/cm² (45.5 erg/cm²). The release property was good. The material of the reflection preventing layer was not attached to the coating layer formed on the minutely concavo-convex shaped surface of the master mold.

### FIRST COMPARATIVE EXAMPLE

The same reflection preventing layer mold as the reflection preventing layer mold of the first embodiment was manufactured, except that the coating layer was not formed on the minutely concavo-convex shaped surface of the master mold. The surface free energy of the minutely concavo-convex shaped surface of the master mold was 5.36 μJ/cm² (53.6 erg/cm²).

Next, the manufactured reflection preventing layer mold was set in the injection mold, ARTON (product name), manufactured by JSR Corporation, that was a material of the reflection preventing layer in its melt state, was injected into the injection opening to thus mold the resin injected mold, and the resin injected mold was released from the master mold. The contact work amount (wbs) of the master mold when the resin injected mold was released from the master mold was 9.3 μJ/cm² (93.0 erg/cm²). The material of the reflection preventing layer was attached to the surface of the master mold so that it is difficult to release the resin injected mold from the master mold.

As mentioned above in detail, according to the present invention, it is possible to manufacture a resin optical component having a minutely concavo-convex shaped surface, on which a plurality of minute concave or convex portions in units of submicrons is formed with a high degree of size precision and it is possible to provide resin optical component mold capable of improving the release property when the resin injected mold is released from the master mold.

1. A resin optical component mold having a minutely concavo-convex shaped surface, on which a plurality of submicron concave or convex portions is formed by injection molding light transmitting resin, comprising a first mold and a second mold for defining a cavity for molding a resin optical component having a concavo-convex shaped surface, on which a plurality of submicron concave or convex portions is formed,
wherein a master mold formed of an inorganic oxide layer having a concavo-convex shaped surface, on which a concavo-convex shape complementary to the concavo-convex shape of the concavo-convex shaped surface of the resin optical component is formed, is provided on at least one internal surface of the first mold and the second mold.

2. The resin optical component mold having the concavo-convex shaped surface according to claim 1, wherein a coating layer whose surface free energy is no more than 4 μj/cm² is formed on the concavo-convex shaped surface of the master mold.

3. The resin optical component mold according to claim 2, wherein the coating layer is formed of a diamond-like carbon layer containing fluorine or a silane compound layer having a fluorine structure.

4. The resin optical component mold according to claim 2, wherein the coating layer is formed of a diamond-like carbon layer containing fluorine, and wherein a gradient is given to the concentration of fluorine in a direction of a thickness of the coating layer.

5. The resin optical component mold according to claim 2, wherein a thickness of the coating layer is no more than 50 nm.

6. The resin optical component mold according to claim 1, wherein the concavo-convex shaped surface of the master mold is coated with a protective film made of a liquid resistant material.

7. The resin optical component mold according to claim 5, wherein a thickness of the protective film is no more than 50 nm.

8. The resin optical component mold according to claim 1, wherein an aspect ratio of the concave or convex portions formed on the concavo-convex shaped surface of the master mold is no less than 1.

9. The resin optical component mold according to claim 1, wherein the master mold is formed of a SiO₂ layer.

10. A method of manufacturing a resin optical component having a concavo-convex shaped surface on which a plurality of submicron concave or convex portions in of is formed, the method comprising:
positioning a first mold and a second mold such that a cavity is formed between the first and second molds, a master mold formed of an inorganic oxide layer provided on at least one internal surface of the first mold and the second mold the master mold having a concavo-convex shaped surface on which a concavo-convex shape complementary to the concavo-convex shape of the concavo-convex shaped surface of the resin optical component is formed: and being provided on at least one internal surface of the first mold and the second mold; and
injection molding light transmitting resin in the cavity to transcribe the concavo-convex shape complementary to the concavo-convex shape of the concavo-convex shaped surface of the master mold is to the resin optical component.

11. The resin optical component mold according to claim 2, wherein an aspect ratio of the concave or convex portions formed on the concavo-convex shaped surface of the master mold is no less than 1.

12. The resin optical component mold according to claim 2, wherein the master mold is formed of a SiO₂ layer.

13. The method of manufacturing a resin optical component according to claim 10, wherein a coating layer whose surface free energy is no more than 4 μJ/cm² is formed on the concavo-convex shaped surface of the master mold.
